(19) United States
(12) Patent Application Publication
(10) Pub. No.: US 2007/0293287 A1
(43) Pub. Date: Dec. 20, 2007

(54) EARPHONE DEVICE CAPABLE OF COMMUNICATING WITH MOBILE COMMUNICATION APPARATUS

(76) Inventor: Ting Kuan Yu, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/755,943

(22) Filed: May 31, 2007

(30) Foreign Application Priority Data
Jun. 1, 2006 (TW) 095119414
Jul. 7, 2006 (TW) 095124960

(51) Int. Cl. H04M 1/00; H04B 1/38

(52) U.S. Cl. 455/575.2; 455/567

(57) ABSTRACT

The invention provides an earphone device. The earphone device according the invention includes a housing, a transmitting/receiving unit, a processor, and a plurality of sensors. The processor is electrically connected to the transmitting/receiving unit and is disposed in the housing. The transmitting/receiving unit is disposed in the housing and is used to receive a trigger signal and to communicate with a communication apparatus. The sensors are disposed on the housing and are electrically connected to the processor. When the processor is driven by the trigger signal to activate the sensors, the processor receives sensed signals sent by the sensors and, according to the sensed signal and a plurality of predetermined values corresponding to the sensors, selectively determines a take-on mode.

### BACKGROUND OF THE INVENTION

1. Field of the Invention

The present invention relates to an electronic device. The electronic device is capable of communicating with a communication apparatus and determining a take-on mode according to sensed signals generated by sensors.

2. Description of the Prior Art

Wireless communication has been playing more and more important roles in daily life, and in particular, the usage frequency of earphone device operating therewith has consequently increased. Currently, the most common earphone device for wireless communication is bluetooth earphone. However, to avoid hurting the ear because of excessively loud ringing or to avoid missing calls because of excessively low ringing, whether the earphone is being worn is an issue in bluetooth usage. Present solutions include trying to determine whether the earphone is worn or not by a sensor, yet there is the problem of misjudgment by the sensors beside the limitations of the sensor device itself, and it could still cause the aforementioned problem. For example, a mechanical device is installed on the hanger of the earphone, and whether the earphone is worn or not is attempted to be determined by the motion of the hanger, but it is questionable that the mechanical device can really identify whether the earphone is hung on an ear or a thicker pocket. In addition, whether the earphone is worn or not is also attempted to be determined by a heat sensor. However, it is still questionable that the heat sensor can really identify whether the earphone is hung on a collar close to the body or is just disposed near a heat source.

Accordingly, the scope of the invention provides an earphone device. The earphone device includes a plurality of sensors. Furthermore, the earphone device synthetically determines whether the earphone device is worn according to the sensed signals generated by the sensors to avoid misjudgment and to solve the problem mentioned above.

### SUMMARY OF THE INVENTION

One scope of the invention provides an electronic device. The electronic device includes a plurality of sensors and can determine whether the electronic device is worn or not according to sensed signals generated by the sensors.

According to a preferred embodiment of the invention, an electronic device such as an earphone device includes a housing, a transmitting/receiving unit, a processor, and a plurality of sensors. The earphone device is capable of communicating with a communication apparatus. The transmitting/receiving unit is disposed in the housing for receiving an incoming call or a trigger signal via the communication apparatus. The processor is disposed in the housing and electrically connected to the transmitting/receiving unit, for receiving the incoming call or the trigger signal from the transmitting/receiving unit. The sensors are respectively electrically connected to the processor and are installed on the housing such that the sensors generate respective sensed signals associated with the surroundings of the housing when activated.

Furthermore, each of the sensors corresponds to a predetermined value. When the processor is driven to activate the sensors by the incoming call or trigger signal, the processor receives the sensed signals from the sensors and selectively determines a take-on mode according to the sensed signals and the predetermined values.

Furthermore, the earphone device further includes an alerting device. The alerting device is electrically connected to the processor and is disposed on the housing. When the processor selectively determines a take-off mode according to the sensed signals and the predetermined values, the alerting device is activated at a first power by the processor. When the processor selectively determines a second take-off mode according to the sensed signals and the predetermined values, the alerting device is activated at a second power, lower than the first power, by the processor.

Besides, the earphone device further includes a user-operable switch. The switch is electrically connected to the processor and is disposed on the housing for generating a switching signal in response to the operation of a user. After the alerting device is activated, the processor inactivates the alerting device in response to the switching signal or controls the alerting device in response to the switching signal to operate at a power lower than the first power.

Therefore, according to the preferred embodiment of the invention, using the sensors can reduce the misjudgment probability to the lowest. Besides, using the switch can avoid hurting ears when establishing a connection and can also avoid a substantial communication defect due to the initial communication lag time of normal communication, which is the unavailable period from the time of pushing down a communication button of the earphone device to correctly using the earphone device.

The advantage and spirit of the invention may be further understood by the following recitations together with the appended drawings.

### BRIEF DESCRIPTION OF THE APPENDED DRAWINGS

FIG. 1 is a schematic diagram illustrating an earphone device according to the first preferred embodiment of the invention.

FIG. 2 is a schematic diagram illustrating an earphone device according to the second preferred embodiment of the invention.

FIG. 3 is a schematic diagram illustrating a position-sensing device.

### DETAILED DESCRIPTION OF THE INVENTION

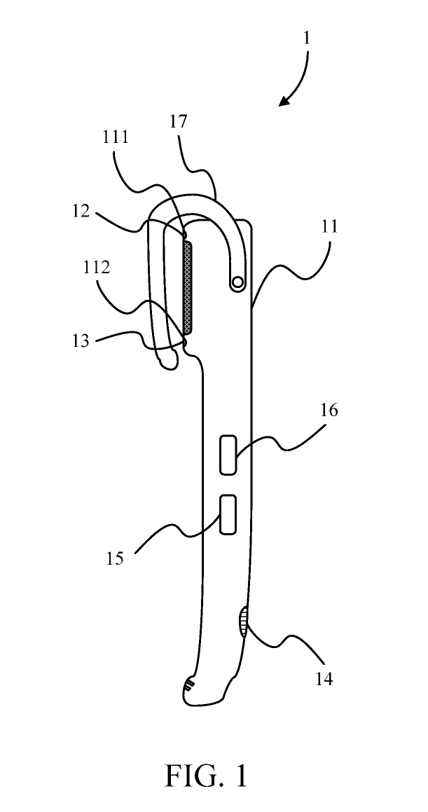

Referring to FIG. 1, FIG. 1 is a schematic diagram illustrating an earphone device according to the first preferred embodiment of the invention. According to the first preferred embodiment, the earphone device 1 includes a housing 11, a transmitting/receiving unit (not shown in FIG. 1), a processor (not shown in FIG. 1), a first sensor 12, a second sensor 13, an alerting device 14, a user-operable switch 15, a communication button 16, and an ear hanger 17. The earphone device 1 can communicate with a communication apparatus (not shown in FIG. 1). The transmitting/receiving unit is disposed in the housing 11 for receiving an incoming call or a trigger signal via the communication apparatus. The processor is disposed in the housing 11 and electrically connected to the transmitting/receiving unit, for receiving the incoming call or the trigger signal from the transmitting/receiving unit. The sensors 12 and 13 are respectively connected to the processor and respectively installed at a first position 111 and a second position 112 on the housing 11, such that when a user uses or a wearer wears the earphone device 1, the sensors 12 and 13 will be close to the user or the wearer. The alerting device 14, the switch 15, and the communication button 16 are respectively electrically connected to the processor and are disposed on the housing 11. According to the first preferred embodiment, the alerting device 14 is a buzzer 14. The communication button 16 is for activating communication. The hanger 17 is pivotally engaged to the housing 11 such that the earphone device 1 can be attached to the ear of the user or the wearer.

Therefore, when the processor is driven by the incoming call or the trigger signal to activate the sensors 12 and 13, the sensors 12 and 13 respectively generate a first sensed signal and a second sensed signal associated with the surroundings of the housing 11. The processor determines that the earphone device 1 is in a take-on mode when the processor receives the first sensed signal and the second sensed signal at the same time.

Furthermore, when the transmitting/receiving unit receives the incoming call or the trigger signal, and the processor receives neither the first sensed signal nor the second sensed signal, the processor determines that the earphone device 1 is in a first take-off mode and activates the buzzer 14 at a first power on the basis of the first take-off mode. Afterward, when the switch 15 generates a switching signal in response to the operation of the user or the wearer, the processor inactivates the buzzer 14 or controls the buzzer 14 to operate at a third power lower than the first power in response to the switching signal.

Similarly, when the transmitting/receiving unit receives the incoming call or the trigger signal, and the processor receives either the first sensed signal or the second signal, the processor determines that the earphone device 1 is at a second take-off mode and activates the buzzer 14 at a second power lower than the first power on the basis of the second take-off mode. Afterward, when the switch 15 generates the switching signal in response to operation of the user or the wearer, the processor inactivates the buzzer 14 or controls the buzzer 14 to operate at a power lower than the second power in response to the switching signal.

In addition, compared with the first preferred embodiment, two sensors of an earphone device of an embodiment respectively correspond to a first predetermined value and a second predetermined value. When the processor of the earphone device is driven by the incoming call or the trigger signal to activate the sensors, the processor receives the sensed signals generated by the sensors and selectively determines what the use or wearing situation of the earphone device is, according to the sensed signals and the predetermined values. This way allows the earphone device to quantitatively compare the sensed signals to identify more use or wearing situations, so as to reduce the misjudgment probability to the lowest.

Besides, compared with the first preferred embodiment, an alerting device of an earphone device of another embodiment is a lighting device, a vibrator, or other device with prompt or alert. Even the earphone device is provided with two or more alerting devices to increase the alert forms and to effectively and correctly alert. The installation of the devices depends on actual products and the properties of the devices and is not limited to the disclosure in the figures.

It should be noted that the predetermined values can be values or other expressions matching the corresponding sensors for comparing with the sensed signals generated by the corresponding sensors. For example, if one of the sensors is an optical sensing device, the corresponding predetermined value will be 1 or 0, for indicating whether the sensed signal exists or not. If one of the sensors is a temperature-sensing device, the corresponding predetermined value will be a value in a certain range, for indicating the intensity of the corresponding sensed signal. Besides, the predetermined values are predetermined, for example, before leaving the factory. The predetermined values can also be changed based on a user's demand, for example, due to the limitation of the environment of usage. One of the predetermined values can even be ignored.

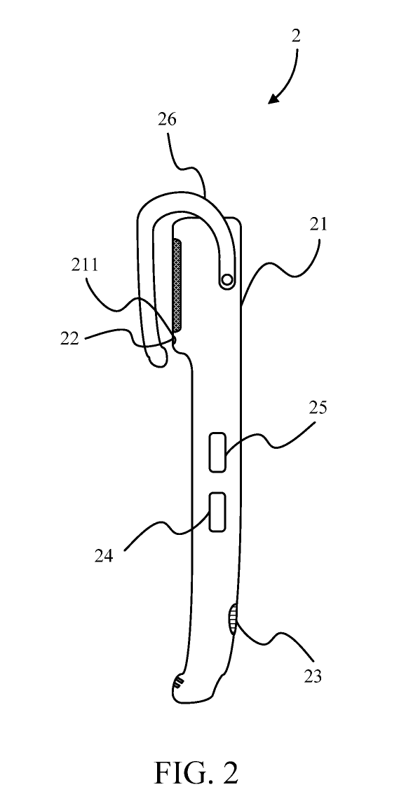

Referring to FIG. 2, FIG. 2 is a schematic diagram illustrating an earphone device according to the second preferred embodiment of the invention. According to the second preferred embodiment, the earphone device 2 includes a housing 21, a transmitting/receiving unit (not shown in FIG. 2), a processor (not shown in FIG. 2), a sensor 22, a vibrator 23, a user-operable switch 24, a communication button 25, and a hanger 26. The earphone device 2 is capable of communicating with a communication apparatus (not shown in FIG. 2). The transmitting/receiving unit is disposed in the housing 21 for receiving an incoming call or a trigger signal via the communication apparatus. The processor is disposed in the housing 21 and electrically connected to the transmitting/receiving unit, for receiving the incoming call or the trigger signal from the transmitting/receiving unit. The sensor 22 is connected to the processor and installed at a position 211 on the housing 21 such that when a user or a wearer wears the earphone device 2, the sensor 22 will be close to the user or the wearer. The vibrator 23, the switch 24, and the communication button 25 are respectively electrically connected to the processor and are disposed on the housing 21. The communication button 25 is for activating communication. The hanger 26 is pivotally engaged to the housing 21 such that the earphone device 2 can be attached to the ear of the user or the wearer.

Therefore, when the processor is driven by the incoming call or the trigger signal to activate the sensor 22, the sensor 22 generates a sensed signal associated with the surroundings of the housing 21. When the processor does not receive the sensed signal, the processor activates the vibrator 23 at a first power.

Furthermore, when the switch 24 generates a switching signal in response to the operation of the user or the wear after the vibrator 23 is activated, the processor inactivates the vibrator 23 or controls the vibrator 23 at a third power lower than the first power in response to the switching signal.

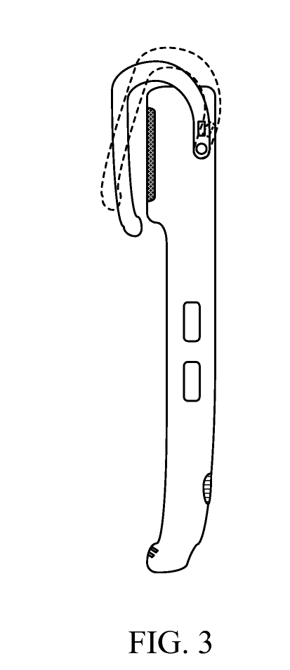

In addition, in the above embodiments, the sensors can be a pressure-sensing device, a temperature-sensing device, a position-sensing device, a conduction-sensing device, an ultrasound-sensing device, an optical sensing device, or other sensing device capable of generating a sensed signal associated with the surroundings of the housing. The installation of the devices depends on actual products and the properties of the devices and is not limited to the disclosure in the figures. Besides, the position-sensing device can be installed on the pivot of the housing where the hanger is pivotally engaged, or on the housing or the hanger near the pivot. The position-sensing device can include a mechanical switch, an electromagnetic induction sensing device, or other sensing device capable of generating a sensed signal in response to a movement or a rotation, as shown in FIG. 3.

Therefore, according to the embodiments of the invention, using the sensors can reduce the misjudgment probability to the lowest. Moreover, using the switch can avoid hurting ears when establishing a connection and can avoid a substantial communication defect due to the initial communication lag time of normal communication, which is the unavailable period from the time of pushing down a communication button of the earphone device to correctly using or wearing the earphone device.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. An electronic device capable of communicating with a communication apparatus, said electronic device comprising:
a housing;
a transmitting/receiving unit for receiving an incoming call via the communication apparatus;
a processor electrically connected to the transmitting/receiving unit, for receiving the incoming call from the transmitting/receiving unit; and
N sensors installed on the housing, N being an integer larger than 1, the N sensors being respectively electrically connected to the processor, the processor activating the N sensors when the processor is triggered by the incoming call, each of the N sensors generates a respective sensed signal in response to the surroundings of the housing when said N sensors are activated;
wherein N predetermined values are respectively corresponding to one of the N sensors, and the processor receives the N sensed signals from the N sensors and selectively determines a take-on mode according to the N sensed signals and the N predetermined values.

2. The electronic device of claim 1, wherein the processor selectively determines a first take-off mode according to the N sensed signals and the N predetermined values.

3. The electronic device of claim 2, further comprising an alerting device electrically connected to the processor, wherein the alerting device is activated by the processor at a first power when the processor determines the first take-off mode.

4. The electronic device of claim 3, wherein the processor also determines a second take-off mode according to the N sensed signals and the N predetermined values, and the alerting device is activated by the processor at a second power lower the first power when the processor determines the second take-off mode.

5. The electronic device of claim 3, wherein the alerting device is one selected from the group consisting of a buzzer, a vibrator, and a lighting device.

6. The electronic device of claim 1, wherein the N sensors comprise one selected from the group consisting of a pressure-sensing device, a temperature-sensing device, a position-sensing device, a conduction-sensing device, an ultrasound-sensing device, and an optical sensing device.

7. An electronic device capable of communicating with a communication apparatus, said electronic device comprising:
a housing;
a transmitting/receiving unit for receiving an incoming call via the communication apparatus;
a processor electrically connected to the transmitting/receiving unit, for receiving the incoming call from the transmitting/receiving unit;
N sensors installed on the housing, N being a natural number, the N sensors being respectively electrically connected to the processor, the processor activating the N sensors when the processor is triggered by the incoming call, each of the N sensors aid sensor generates a respective sensed signal in response to the surroundings of the housing when said N sensors are activated; and
an alerting device electrically connected to the processor;
wherein N predetermined values are respectively corresponding to one of the N sensors, and the processor receives the N sensed signals from the N sensors, selectively determines a first take-off mode according to the N sensed signals and the N predetermined values, and activates the alerting device at a first power on the basis of the first take-off mode.

8. The electronic device of claim 7, wherein N is an integer larger than 1, and the processor selectively determines a second take-off mode according to the N sensed signals and the N predetermined values and activates the alerting device at a second power lower than the first power on the basis of the second take-off mode.

9. The electronic device of claim 7, wherein the alerting device is one selected from the group consisting of a buzzer, a vibrator, and a lighting device.

10. The electronic device of claim 7, wherein the N sensors comprise one selected from the group consisting of a pressure-sensing device, a temperature-sensing device, a position-sensing device, a conduction-sensing device, an ultrasound-sensing device, and an optical sensing device.

11. An electronic device capable of communicating with a communication apparatus, said electronic device comprising:
a housing;
a transmitting/receiving unit for receiving an incoming call via the communication apparatus;
a processor electrically connected to the transmitting/receiving unit, for receiving the incoming call from the transmitting/receiving unit;
N sensors installed on the housing, N being a natural number, the N sensors being respectively electrically connected to the processor, the processor activating the N sensors when the processor is triggered by the incoming call, each of the N sensors being installed on the housing such that said sensor generates a respective sensed signal in response to the surroundings of the housing when said N sensors are activated;
an alerting device electrically connected to the processor, wherein N predetermined values are respectively corresponding to one of the N sensors, and the processor receives the N sensed signals from the N sensors, selectively determines a first take-off mode according to the N sensed signals and the N predetermined values, and activates the alerting device at a first power on the basis of the first take-off mode; and
a user-operable switch, disposed on the housing and electrically connected to the processor, for generating a switching signal in response to operation of the user, wherein the processor selectively inactivates the alerting device in response to the switching signal after the processor activates the alerting device on the basis of the first take-off mode.

12. The electronic device of claim 11, wherein the processor also selectively controls the alerting device to operate at a third power lower than the first power after the processor activates the alerting device at the first power on the basis of the first take-off mode.

13. The electronic device of claim 11, wherein N is an integer larger than 1, and the processor also selectively determines a second take-off mode according to the N sensed signals and the N predetermined values and activates the alerting device at a second power lower than the first power on the basis of the second take-off mode.

14. The electronic device of claim 11, wherein the alerting device is one selected from the group consisting of a buzzer, a vibrator, and a lighting device.

15. The electronic device of claim 11, wherein the N sensors comprise one selected from the group consisting of a pressure-sensing device, a temperature-sensing device, a position-sensing device, a conduction-sensing device, an ultrasound-sensing device, and an optical sensing device.

16. An electronic device, comprising:
a housing;
a first sensor, installed at a first position on the housing, when a user uses the electronic device, the first position being close to the user such that the first sensor generates a first sensed signal;
a second sensor, installed at a second position on the housing, the first position being different from the second position, when the user uses the electronic device, the second position being close to the user such that the second sensor generates a second sensed signal; and
a processor electrically connected to the first sensor and the second sensor;
wherein the processor determines that the electronic device is at a take-on mode when the processor simultaneously receives both the first sensed signal and the second sensed signal.

17. The electronic device of claim 16, further comprising a transmitting/receiving unit electrically connected to the processor, for receiving a trigger signal from a wireless communication apparatus, the electronic device communicating with the wireless communication apparatus via the transmitting/receiving unit.

18. The electronic device of claim 17, further comprising an alerting device electrically connected to the processor.

19. The electronic device of claim 18, wherein when the transmitting/receiving unit receives the trigger signal and the processor receives either the first sensed signal or the second sensed signal, the processor activates the alerting device at a second power.

20. The electronic device of claim 19, wherein when the transmitting/receiving unit receives the trigger signal and the processor receives neither the first sensed signal nor the second sensed signal, the processor activates the alerting device at a first power, the first power being higher than the second power.

21. The electronic device of claim 18, wherein the alerting device is one selected from the group consisting of a buzzer, a vibrator, and a lighting device.

22. The electronic device of claim 16, wherein the first sensor and the second sensor comprise one selected from the group consisting of a pressure-sensing device, a temperature-sensing device, a position-sensing device, a conduction-sensing device, an ultrasound-sensing device, and an optical sensing device.

23. An electronic device, comprising:
a housing;
a first sensor, installed at a first position on the housing, when a user uses the electronic device, the first position being close to the user such that the first sensor generates a first sensed signal;
a processor electrically connected to the first sensor;
a transmitting/receiving unit electrically connected to the processor, for receiving a trigger signal from a wireless communication apparatus, the electronic device communicating with the wireless communication apparatus via the transmitting/receiving unit; and
a vibrator electrically connected to the processor;
wherein when the transmitting/receiving unit receives the trigger signal but the processor does not receive the first sensed signal, the processor activates the vibrator at a first power.

24. The electronic device of claim 23, further comprising a second sensor, electrically connected to the processor and installed at a second position on the housing different from the first position, when the user uses the electronic device, the second position being close to the user such that the second sensor generates a second sensed signal, wherein when the transmitting/receiving unit receives the trigger signal and the processor does not receive the first sensed signal but the second sensed signal, the processor activates the vibrator at a second power.

25. The electronic device of claim 23, wherein the first sensor is one selected from the group consisting of a pressure-sensing device, a temperature-sensing device, a position-sensing device, a conduction-sensing device, an ultrasound-sensing device, and an optical sensing device.

26. An electronic device communicating with a wireless communication apparatus, comprising:
a housing;
a first sensor, installed at a first position on the housing, when a user uses the electronic device, the first position being close to the user such that the first sensor generates a first sensed signal;
a processor electrically connected to the first sensor;
a transmitting/receiving unit electrically connected to the processor, for receiving a trigger signal from the wireless communication apparatus;
an alerting device electrically connected to the processor; and
a user-operable switch electrically connected to the processor, for generating a switching signal in response to operation of the user;
wherein when the transmitting/receiving unit receives the trigger signal and none of the first sensed signal and the switching signal received by the processor, the processor activates the alerting device at a first power; wherein when the transmitting/receiving unit receives the trigger signal and one of the first sensed signal and the switching signal received by the processor, the processor inactivates the alerting device or activates the alerting device at a third power lower than the first power.

27. The electronic device of claim 26, further comprising a second sensor, electrically connected to the processor and installed at a second position on the housing different from the first position, when the user uses the electronic device, the second position being close to the user such that the second sensor generates a second sensed signal, wherein when the transmitting/receiving unit receives the trigger signal and the processor does not receive the first sensed signal but the second sensed signal, the processor activates the alerting device at a second power.

28. The electronic device of claim 26, wherein the alerting device is one selected from the group consisting of a buzzer, a vibrator, and a lighting device.

29. The electronic device of claim 26, wherein the first sensor is one selected from the group consisting of a pressure-sensing device, a temperature-sensing device, a position-sensing device, a conduction-sensing device, an ultrasound-sensing device, and an optical sensing device.
